(19) United States
(12) Patent Application Publication
(10) Pub. No.: US 2026/0116181 A1
(43) Pub. Date: Apr. 30, 2026

(54) METHOD AND SYSTEM FOR CONTROLLING AN ACCESS PANEL TO A RECHARGING DEVICE OF A MOTOR VEHICLE

(71) Applicant: AMPERE S.A.S., Boulogne Billancourt (FR)

(72) Inventors: Khalid KHETARI, Guyan (FR); Eric MINSSEN, Guyancourt (FR)

(73) Assignee: AMPERE S.A.S., Boulogne Billancourt (FR)

(21) Appl. No.: 18/998,303

(22) PCT Filed: Jun. 27, 2023
(86) PCT No.: PCT/EP2023/067463

§ 371 Date: Dec. 29, 2025

(30) Foreign Application Priority Data
Aug. 1, 2022 (FR) FR2207968

(51) Int. Cl. B60K 15/05; B60K 15/03; B60L 53/16; E05F 15/73; E05F 15/77; E05F 15/79

(52) U.S. Cl. CPC B60K 15/05; B60L 53/16; E05F 15/73; E05F 15/77; E05F 15/79; B60K 2015/0323; B60K 2015/03315; B60K 2015/053; B60K 2015/0538; E05F 2015/767; E05Y 2900/534

(57) ABSTRACT

A method for controlling an access panel to a recharging device of a motor vehicle powered by an electric and/or heat engine and including a sensor for detecting an external environment of the vehicle, a system for detecting a badge worn by a user and a sensor configured to detect whether the engine of the vehicle is switched off. In the method, data are recovered, the system for detecting a badge worn by the user and the sensor configured to detect whether the engine of the motor vehicle is switched off, when the vehicle is stationary and the badge is detected by the badge detection system, the sensor for detecting the external environment of the vehicle and a system for recognizing a charger of the recharging device are activated, and when the charger is detected, the panel is automatically opened in a position allowing access to the recharging device.

The present invention relates to the field of motor vehicles and in particular to flaps allowing access to a device for recharging a vehicle with electric energy or refueling it with fossil fuel.

It is known to provide a flap allowing access to an aperture in a body part of a motor vehicle, in order to allow a device for recharging/refueling the vehicle to be reached.

Current motor vehicles are provided with propulsion means that are powered by electric energy and/or fossil fuel. Their energy resources are stored in a device for storing electrical energy, such as one or more electric batteries, and/or in fuel tanks.

In so-called “electric” motor vehicles, the access flap allows access to an electrical socket configured to allow a device for storing electrical energy, such as one or more electric batteries, to be recharged. Once the access flap is in an open position, the device for storing electrical energy may be recharged with electrical energy via a power cable connected to an electrical grid external to the vehicle.

In so-called “ICE” or “hybrid” motor vehicles, the access flap allows access to a fuel tank.

Generally, the flap allowing access to a recharging/refueling device is mounted so as to be able to pivot, with respect to an aperture in a body part of the vehicle, between a closed position in which the flap completely obturates the aperture and an open position in which the aperture is unobstructed.

An intermediate lid may be present in order to obturate the recharging/refueling device even when the flap is in the open position.

The interested reader may refer to documents FR2925458 and FR2731391, which describe examples of structures of flaps allowing access to a device for recharging/refueling a motor vehicle.

However, to open and close such access flaps the user of the vehicle must intervene to open the flap and then the intermediate lid, this increasing recharging/refueling time and potentially resulting in the hands of the user getting dirty, and moreover requiring the user to have both hands free.

Thus, there is a need to make it easier to open and close flaps allowing access to the device for recharging/refueling a motor vehicle.

The objective of the invention is therefore to overcome these drawbacks and to make it easier to open and close flaps allowing access to the device for recharging/refueling a motor vehicle.

One subject of the present invention is a method for opening and/or closing a flap allowing access to a device for recharging/refueling a motor vehicle that is propelled electrically and/or by internal combustion and that comprises at least a sensor for detecting the external environment of the vehicle, a system for detecting a key card carried by the user and a sensor configured to detect that the motor of the motor vehicle is off, i.e. that the vehicle is stationary.

The sensor configured to detect that the motor of the motor vehicle is off may for example be a speed sensor capable of detecting a speed of zero, or a parking-brake sensor capable of detecting that the parking brake is activated.

In the method,
data delivered at least by the sensor for detecting the external environment of the vehicle, the system for detecting a key card carried by the user and the speed sensor of the motor vehicle, are collected;
when the vehicle is stationary, i.e. the motor is off, and the key card is detected by the system for detecting a key card, the sensor for detecting the external environment of the vehicle and a system for recognizing a recharging/refueling means of the recharging/refueling device are activated.

When a recharging/refueling means is detected by the system for recognizing a recharging/refueling means, the flap is automatically opened to a position allowing access to the recharging/refueling device.

Advantageously, in the step of automatically opening the flap to a position allowing access to the recharging/refueling device, an actuator configured to open said flap is actuated.

For example, the flap is automatically closed when the recharging/refueling means is removed from the aperture of the device for recharging/refueling the vehicle, after a predetermined length of time, for example between 30 seconds and 2 minutes.

As a variant, the flap could be automatically closed, when the recharging/refueling means has been withdrawn from the aperture of the device for recharging/refueling the vehicle and after the user has moved away from said flap by a distance greater than or equal to 80 cm.

The recharging/refueling means may be selected from an electric charging connector and a nozzle for delivering fuel or hydrogen.

For example, the system for recognizing a recharging/refueling means comprises a database provided by the vehicle manufacturer containing every existing type of recharging/refueling means.

The recharging/refueling means may be recognized via detection of the shape of said recharging/refueling means and/or of a visual means present on the recharging/refueling means, such as a logo, a bar code or a QR code (QR being the acronym of Quick-Response).

According to a second aspect, the invention relates to a system for controlling a flap allowing access to a device for recharging/refueling a motor vehicle that is propelled electrically and/or by internal combustion and that comprises at least a sensor for detecting the external environment of the vehicle, a system for detecting a key card carried by the user and a sensor configured to detect that the motor of the motor vehicle is off, i.e. that the vehicle is stationary.

The sensor configured to detect that the motor of the motor vehicle is off may for example be a speed sensor capable of detecting a speed of zero, or a parking-brake sensor capable of detecting that the parking brake is activated.

The control system comprises a module for collecting data delivered by at least the sensor for detecting the external environment of the vehicle, the system for detecting a key card carried by the user and the speed sensor of the motor vehicle, i.e. the sensor detecting that the motor is off, and a module for activating the sensor for detecting the external environment of the vehicle and a system for recognizing a recharging/refueling means of the recharging/refueling device when the vehicle is stationary.

The control system further comprises a module for automatically opening the flap to a position allowing access to the recharging/refueling device when a recharging/refueling means is detected by the system for recognizing a recharging/refueling means.

For example, the control system comprises a module for automatically closing the flap when the recharging/refueling means is removed from the aperture of the device for recharging/refueling the vehicle, after a predetermined length of time, for example between 30 seconds and 2 minutes.

As a variant, the flap could be automatically closed, when the recharging/refueling means has been withdrawn from the aperture of the device for recharging/refueling the vehicle and after the user has moved away from said flap by a distance greater than or equal to 80 cm.

According to another aspect, the invention relates to a motor vehicle comprising at least a sensor for detecting the external environment of the vehicle, a system for detecting a key card carried by the user, a speed sensor of the motor vehicle configured to detect that the motor of the motor vehicle is off, i.e. that the vehicle is stationary, at least one flap allowing access to a recharging/refueling device and a system for controlling said flap such as described above.

Other aims, features and advantages of the invention will become apparent on reading the following description, which is given merely by way of non-limiting example, and with reference to the appended drawings, in which:

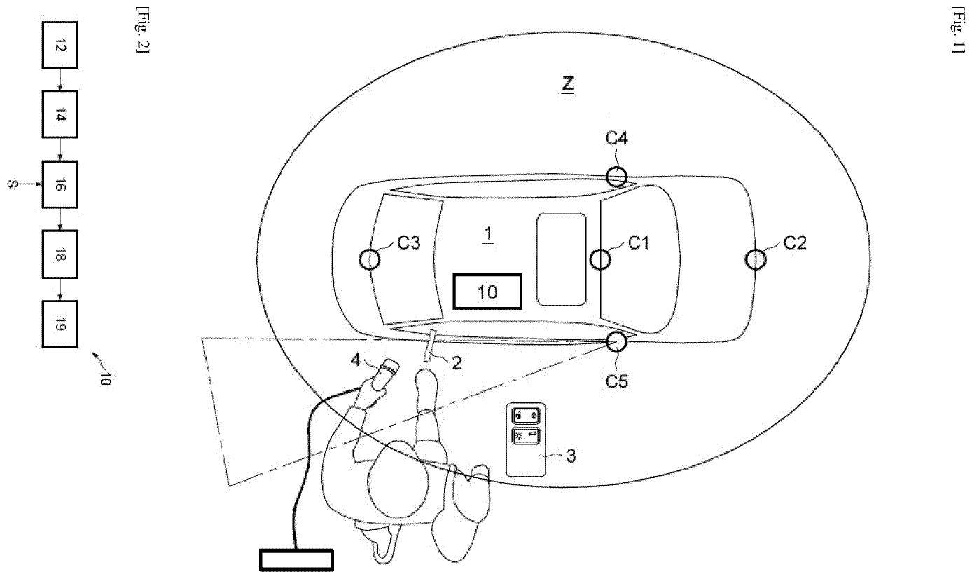

FIG. 1 is a schematic view of a motor vehicle comprising a flap allowing access to a device for recharging/refueling a motor vehicle and a system for controlling said access flap according to one embodiment of the invention;

FIG. 2 shows in detail the control system of FIG. 1; and

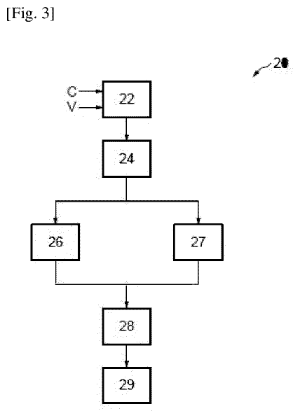

FIG. 3 shows a flowchart of a method for controlling a flap allowing access to a device for recharging/refueling a motor vehicle according to one embodiment of the invention, implemented by the control system of FIG. 2.

FIG. 1 shows, very schematically, a motor vehicle 1 comprising a flap 2 allowing access to a device for recharging/refueling the vehicle and a system 10 for controlling opening and/or closing of said flap 2.

The motor vehicle 1 further comprises one or more exteroceptive sensors C, such as for example here two front cameras C1, C2, a rear camera C3 and two side cameras C4, C5.

Generally, the motor vehicle 1 further comprises one or more cameras defining a field of detection Z, here of 360°.

By exteroceptive sensors, what is meant is sensors capable of collecting information on the external environment close to the vehicle.

As illustrated in detail in FIG. 2, the system 10 for controlling the flap 2 comprises a module 12 for collecting data delivered by the exteroceptive sensors C, by a system for detecting a key card 3 carried by the user, and by speed data of the motor vehicle. The key card may for example be a specific key, or an application provided on a smartphone.

The system 10 for controlling the flap 2 further comprises a module 14 for determining whether the motor vehicle is stationary.

If the speed V of the vehicle is zero, the module 14 determines that the vehicle is stationary, i.e. the motor is off. The module 14 could also detect that the vehicle is stationary if the parking brake is activated.

The system 10 for controlling the flap 2 further comprises a module 16 for activating the exteroceptive sensors C when the vehicle is stationary and the key card 3 is detected outside the vehicle.

Provision could be made for the control module 16 to activate only the exteroceptive sensor C located in proximity to the key card 3.

Simultaneously with activation of the one or more exteroceptive sensors C, the control module 16 activates a system S for recognizing a recharging/refueling means 4, for example an electric charging connector or a nozzle for delivering fuel or hydrogen. The system S for recognizing a recharging/refueling means comprises a database provided by the vehicle manufacturer containing every existing type of recharging/refueling means.

The recharging/refueling means 4 may be recognized via the shape of said recharging/refueling means but also via a visual means, such as a logo, a bar code or a QR code (QR being the acronym of Quick-Response) or any other suitable visual means.

The system 10 for controlling the flap 2 further comprises a module 18 for automatically opening the flap 2 when a recharging/refueling means is detected by the system S for recognizing a recharging/refueling means.

The module 18 for opening the flap 2 is configured to actuate an actuator (not shown) allowing said flap 2 to be opened.

Thus, the user is able to directly engage the recharging/refueling means into the aperture of the device for recharging/refueling the vehicle.

The system 10 for controlling the flap 2 may also comprise a module 19 for automatically closing the flap 2 when the recharging/refueling means 4 is removed from the aperture of the device for recharging/refueling the vehicle, in particular after a predetermined length of time, for example between 30 seconds and 2 minutes.

As illustrated in FIG. 3, the method 20 for controlling the flap 2 comprises a step 22 of collecting data delivered by the exteroceptive sensors C, by a system (not shown) for detecting a key card 3 carried by the user, and by speed data of the motor vehicle. The key card 3 may for example be a specific key, or an application provided on a smartphone.

The method 20 for controlling the flap 2 further comprises a step 24 of determining whether the motor vehicle is stationary.

If the speed V of the vehicle is zero, the vehicle is considered to be stationary.

The method 20 for controlling the flap 2 further comprises a step 26 for activating the exteroceptive sensors C when the vehicle is stationary and the key card 3 is detected outside the vehicle.

Provision could be made, in step 26, to activate only the exteroceptive sensor C located in proximity to the key card 3.

Simultaneously with activation of the one or more exteroceptive sensors C, a system S for recognizing a recharging/refueling means 4, for example an electric charging connector or a nozzle for delivering fuel or hydrogen, is activated in step 27. The system S for recognizing a recharging/refueling means comprises a database provided by the vehicle manufacturer containing every existing type of recharging/refueling means.

The recharging/refueling means 4 may be recognized via the shape of said recharging/refueling means but also via a visual means, such as a logo, a bar code or a QR code (QR being the acronym of Quick-Response) or any other suitable visual means.

Next, in step 28, the flap 2 is automatically opened to a position allowing access to the recharging/refueling device when a recharging/refueling means is detected by the system S for recognizing a recharging/refueling means 4.

In step 28, an actuator (not shown) allowing said flap 2 to be opened is actuated.

Thus, when the vehicle is stationary, on approach of a user carrying a key card and a recharging/refueling means, the recharging/refueling flap is automatically moved to the open position, allowing access to the device for recharging/refueling the vehicle.

The method 10 for controlling the flap 2 may also comprise a step 29 of automatically closing the flap 2 when the recharging/refueling means 4 is removed from the aperture of the device for recharging/refueling the vehicle, in particular after a predetermined length of time, for example between 30 seconds and 2 minutes.

By virtue of the invention, the process of recharging/refueling the vehicle is simplified and improved.

1. A method for controlling a flap allowing access to a device for recharging/refueling a motor vehicle that is propelled electrically and/or by internal combustion and that comprises at least a sensor for detecting an external environment of the vehicle, a system for detecting a key card carried by a user and a sensor configured to detect that the motor of the motor vehicle is off, wherein:
data delivered at least by the sensor for detecting the external environment of the vehicle, the system for detecting a key card carried by the user and the sensor configured to detect that the motor of the motor vehicle is off, are collected;
when the vehicle is stationary and the key card is detected by the system for detecting a key card, the sensor for detecting the external environment of the vehicle and a system for recognizing a recharging/refueling means of the recharging/refueling device are activated, and
when a recharging/refueling means is detected by the system for recognizing a recharging/refueling means, the flap is automatically opened to a position allowing access to the recharging/refueling device.

2. The control method as claimed in claim 1, wherein, in the automatically opening of the flap to a position allowing access to the recharging/refueling device, an actuator configured to open said flap is actuated.

3. The control method as claimed in claim 1, wherein the flap is automatically closed when the recharging/refueling means is removed from an aperture of the device for recharging/refueling the vehicle, after a predetermined length of time.

4. The control method as claimed in claim 1, wherein the recharging/refueling means is selected from an electric charging connector and a nozzle for delivering fuel or hydrogen.

5. The control method as claimed in claim 1, wherein the system for recognizing a recharging/refueling means comprises a database provided by a vehicle manufacturer containing every existing type of recharging/refueling means.

6. The control method as claimed in claim 1, wherein the recharging/refueling means is recognized via detection of a shape of said recharging/refueling means and/or of a visual means present on the recharging/refueling means.

7. A system for controlling a flap allowing access to a device for recharging/refueling a motor vehicle that is propelled electrically and/or by internal combustion and that comprises at least a sensor for detecting an external environment of the vehicle, a system for detecting a key card carried by a user and a sensor configured to detect that the motor of the motor vehicle is off, comprising:
a module for collecting data delivered by at least the sensor for detecting the external environment of the vehicle, the system for detecting a key card carried by the user and the sensor configured to detect that the motor of the motor vehicle is off;
a module for activating the sensor for detecting the external environment of the vehicle and a system for recognizing a recharging/refueling means of the recharging/refueling device when the vehicle is stationary, and
a module for automatically opening the flap to a position allowing access to the recharging/refueling device when a recharging/refueling means is detected by the system for recognizing a recharging/refueling means.

8. The control system as claimed in claim 7, comprising a module for automatically closing the flap when the recharging/refueling means is removed from an aperture of the device for recharging/refueling the vehicle, after a predetermined length of time.

9. A motor vehicle comprising at least a sensor for detecting the external environment of the vehicle, a system for detecting a key card carried by the user, a sensor configured to detect that the motor of the motor vehicle is off, at least one flap allowing access to a recharging/refueling device and a system for controlling said flap as claimed in claim 7.
